(19) United States
(12) Patent Application Publication
(10) Pub. No.: US 2022/0273516 A1
(43) Pub. Date: Sep. 1, 2022

(54) SMART MEDICINE BOX

(71) Applicant: DNX (DESIGN FOR NEXT EXPERIENCE) CO., LTD., Yongin-si (KR)

(72) Inventor: Eun Kyeong Kwon, Gwacheon-si (KR)

(21) Appl. No.: 17/209,897

(22) Filed: Mar. 23, 2021

(30) Foreign Application Priority Data
Feb. 26, 2021 (KR) 10-2021-0026470

(51) Int. Cl. A61J 1/03; A61J 7/04

(52) U.S. Cl. CPC A61J 1/03; A61J 7/04; A61J 2205/60

(57) ABSTRACT

A smart medicine box is proposed. The smart medicine box includes a medicine accommodation portion having a plurality of accommodation spaces that are opened at a front thereof and accommodate medicine that is to be taken, and a closing portion that covers a front of the medicine accommodation portion to protect the medicine and is opened to take the medicine out from the box. The smart medicine box is configured by assembling a plurality of unit cases, so that a large mold for manufacturing the smart medicine box is not required, manufacturing cost is low, and consequently the smart medicine box can be supplied at low cost. Furthermore, different colors are provided for individual unit cases, and the unit case of different colors are combined in various ways, thus allowing a user to more easily distinguish the day of the week or the date.

### CROSS REFERENCE TO RELATED APPLICATION

The present application claims priority to Korean Patent Application No. 10-2021-0026470, filed Feb. 26, 2021, the entire contents of which are incorporated herein for all purposes by this reference.

### BACKGROUND OF THE INVENTION

### Field of the Invention

The present disclosure relates to a smart medicine box. More particularly, the present disclosure relates to a smart medicine box, which has an assemblable structure to reduce manufacturing cost and make it convenient to use, and which can inform whether a user takes medicine.

### Description of the Related Art

As the number of elderly people increases and medical standards for various diseases become stricter, the number of chronic patients who have to take medicine for a lengthy period of time is increasing. It is very important for a person who is to be administered for a lengthy period of time (hereinafter, referred to as a long-term patient) to take prescribed medicine according to a purpose. The reason is because the disease may not be properly treated and side effects may occur in some cases if the administration method suitable for the purpose is not followed.

However, it is not easy for a chronic patient to follow an optimal administration method. As for elderly people, most of them have bad memory and forgetfulness. Further, even if a patient is not elderly, the patient may forget whether he or she has taken medicine or not, or may forget even the fact that he or she should take medicine due to a busy social life.

For this reason, various administration managing systems or devices for long-term patients have been proposed. For example, a device for outputting an alarm at a preset administration time and displaying medicine that should be taken, or a device for informing whether a user has taken medicine or not using a weight sensor has been proposed. However, it is impossible to know if a user actually takes medicine using these types of systems.

Furthermore, a medicine box configured such that the box itself has the configuration of a calendar and medicine is previously put into a space corresponding to each date has been developed. However, such a calendar type of medicine box should have at least 31 medicine receiving spaces (because one month has a maximum of 31 days), and each individual space should a volume to accommodate medicine therein, so that the size of the medicine box may be inevitably increased. In other words, the size of a mold for injection molding the medicine box is increased.

As is well known to those skilled in the art, the cost of manufacturing a mold for injection-molding synthetic resin may be increased, as the size of the mold itself is increased. Consequently, the conventional calendar type of medicine box has a drawback in that cost of mold as well as cost of a product is added, so that the medicine box may not be manufactured and suppled at low cost. Since the medicine box itself is not inexpensive, it is difficult to purchase and use the box.

As technology related to administration, Korean Patent No. 10-1994258 entitled “Portable Medicine Calendar” has been disclosed.

The medicine calendar includes a calendar body that has on a front thereof a plurality of transparent portions, and has on a rear thereof a magnet to attach the body to a magnetic wall, and a medicine pocket that is detachably attached to the transparent portion of the calendar body has on an upper portion thereof an opening, and is shaped so that the upper portion thereof is wide and a lower portion thereof is narrow. The calendar body has on a side thereof a cut groove, and a white board is put into and taken out from the body through the cut groove. If a date is marked on the white board, the marked date is visible through the transparent portion. The medicine pocket is composed of a plurality of transparent pockets and net pockets. A first marking portion on which a month is marked is detachably attached to a side of the calendar body, a second marking portion on which the day of the week is marked is detachably attached to an upper side of the transparent portion of the calendar body, and a third marking portion on which a day is marked is detachably attached to a surface of the medicine pocket. The calendar body may be used horizontally and vertically. A guide body is provided on each of upper and lower surfaces of the cut groove, and a guide groove is formed on a surface of the guide body. A guide protrusion is provided on each of upper and lower surfaces of the white board, and the guide protrusion is configured to be movably inserted into the guide groove.

### SUMMARY OF THE INVENTION

Accordingly, the present disclosure has been made keeping in mind the above problems occurring in the related art, and an objective of the present disclosure is to provide a smart medicine box, in which manufacturing cost is low so that the box can be supplied at low cost, and a different color is provided for each day of the week, thus allowing a user to more easily distinguish the day of the week or the date, and it is possible to remotely check whether to take medicine, so that it may serve as a communication medium capable of efficiently instructing administration.

In order to achieve the objective of the present disclosure, the present disclosure provides a smart medicine box, including a medicine accommodation portion having a plurality of accommodation spaces that are opened at a front thereof and accommodate medicine that is to be taken; and a closing portion that covers a front of the medicine accommodation portion to protect the medicine and is opened to take the medicine out from the box.

The closing portion may include a sensor portion configured to detect opening of the closing portion.

The medicine accommodation portion may be a case assembly made by assembling a plurality of unit cases that may be assembled with and disassembled from each other while each having an accommodation space that is opened at a front thereof.

Further, an individual container configured to contain medicine that is to be taken may be accommodated in the accommodation space of the unit case.

The unit case may include a bottom portion configured to hold the individual container, and sidewall portions integrally provided on both ends of the bottom portion in a width direction thereof to correspond to both sides of the individual container, one sidewall portion among both the sidewall portions may include a holder having a fitting hole, and an opposite sidewall portion may include a locking buckle coupled to the fitting hole of an adjacent unit case in a lateral direction, a receiving hole opened at a front may be formed in an upper end of each of the sidewall portions, and a fitting protrusion may be located on an underside of the bottom portion to be fitted into the receiving hole of a unit case that is vertically adjacent to the unit case.

The sidewall portion may include an individual-container exposure groove configured to expose a side of the individual container accommodated in the accommodation space of the unit case, thus allowing a user to hold both sides of the individual container in the unit case.

The smart medicine box may further include a support frame having a shape of a rectangular frame to accommodate and support the case assembly.

In addition, a closing-portion supporter may be further installed on a top of the case assembly to support an upper end of the closing portion.

The closing portion may be a closing cover that is formed of a flexible sheet having an area that may cover a front of the case assembly, and is closed by the action of gravity while being supported at an upper end thereof by the closing-portion supporter.

Furthermore, the closing cover may further include a cover-sensor portion configured to detect that a user lifts the closing cover, and to transmit detected contents to the outside.

The closing-portion supporter may include a horizontal receiving portion that has a predetermined width and is opened at a front thereof, and the horizontal receiving portion may be equipped with a marking portion on which the days of week are marked.

The closing-portion supporter may include a horizontal receiving portion that has a predetermined width and is opened at a front thereof, and the horizontal receiving portion may be equipped with a portable medicine box that separately contains medicine for each day of the week.

In addition, the closing-portion supporter may include a plurality of upper cases that provide article accommodation spaces and are coupled to each other while being adjacent to each other in a lateral direction.

Each of the upper cases may further include a front pocket that is separated from the article accommodation space and accommodates a marking portion on which the day of the week is marked.

The individual container may be a receiving case configured to receive medicine for each day of the week, and may include therein a partition wall configured to partition a space of the individual container.

The individual container may further include a container-sensor portion configured to generate a motion signal of the individual container and transmit the motion signal to the outside, when the individual container is moved in a state where a user lifts the closing cover.

The smart medicine box of the present disclosure is configured by assembling a plurality of unit cases, so that a large mold for manufacturing the smart medicine box is not required, manufacturing cost is low, and consequently the smart medicine box can be supplied at low cost.

Furthermore, different colors are provided for individual unit cases, and the unit case of different colors are combined in various ways, thus allowing a user to more easily distinguish the day of the week or the date.

In addition, when a part of the smart medicine box is damaged, only a damaged unit case is replaced with a new one, thus ensuring simple maintenance and allowing the box to be used for a lengthy period of time.

Moreover, the smart medicine box is provided with a curtain-type closing cover, thus preventing the medicine box from spilling forwards, and a closing cover is equipped with a sensor and the sensor is connected to a terminal and an external manager, so that it can serve as a communication medium capable of remotely instructing administration.

### BRIEF DESCRIPTION OF THE DRAWINGS

The above and other objectives, features, and other advantages of the present disclosure will be more clearly understood from the following detailed description when taken conjointly with the accompanying drawings, in which:

FIG. 1 is a perspective view of a smart medicine box according to an embodiment of the present disclosure.

FIG. 2 is an exploded perspective view of the smart medicine box shown in FIG. 1.

FIG. 3 is a side view of the smart medicine box shown in FIG. 1.

FIGS. 4 and 5 are diagrams illustrating a method of assembling unit cases of FIG. 2.

FIG. 6 is a block diagram illustrating a method of using the smart medicine box shown in FIG. 1.

FIG. 7 is a diagram showing a smart medicine box according to a modification of the present disclosure.

FIG. 8 is a cutaway perspective view of an individual container that may be applied to the smart medicine box of FIG. 7.

FIG. 9 is a sectional view showing the individual container accommodated in a unit case of FIG. 7.

FIG. 10 is a block diagram illustrating a method of using the smart medicine box of the modification shown in FIG. 7.

FIG. 11 is a diagram showing a portable medicine box that may be applied to the smart medicine box according to an embodiment of the present disclosure.

FIG. 12 is a perspective view showing a smart medicine box to which another type of closing-portion supporter is applied.

FIG. 13 is a diagram showing the structure of an upper case forming the closing-portion supporter of FIG. 12.

### DETAILED DESCRIPTION OF THE INVENTION

Hereinafter, an embodiment of the present disclosure will be described in detail with reference to the accompanying drawings.

A smart medicine box of the present disclosure is used by a long-term patient, and is made by assembling a plurality of injection-molded unit cases with each other. The unit cases contain medicine for each day of the week, and are assembled vertically and horizontally to have the form of a calendar. Particularly, since the unit cases of small sizes are produced through injection molding and then the injection-molded unit cases are assembled, a large mold for manufacturing the smart medicine box is not required, manufacturing cost is low, and consequently it is possible to supply the smart medicine box at low cost.

Such a smart medicine box essentially includes a medicine accommodation portion having a plurality of accommodation spaces that are opened at a front thereof and accommodate medicine that is to be taken, and a closing portion that covers the front of the medicine accommodation portion to protect the medicine and is opened to take the medicine out from the box.

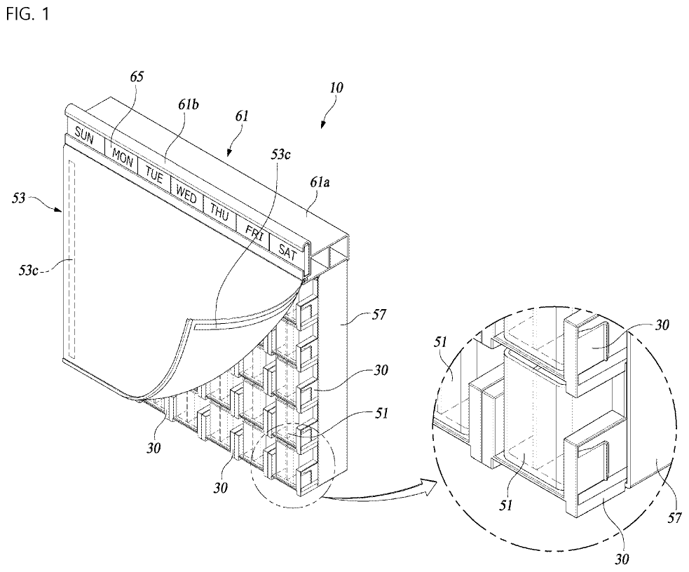

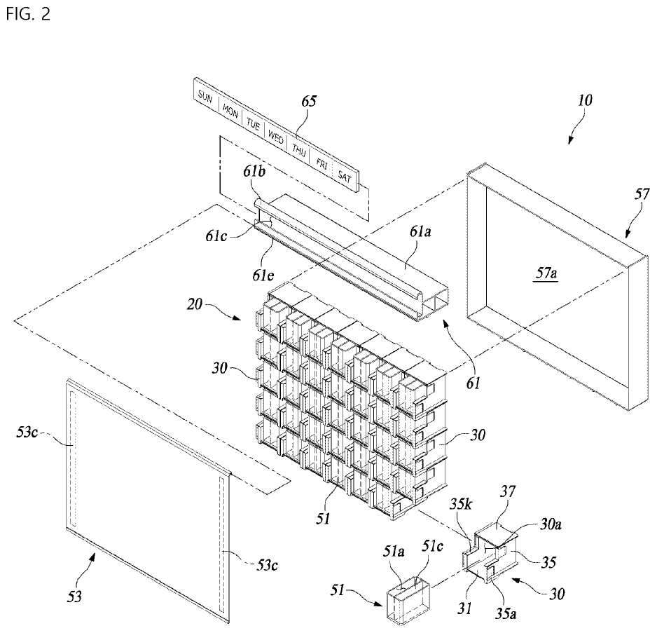

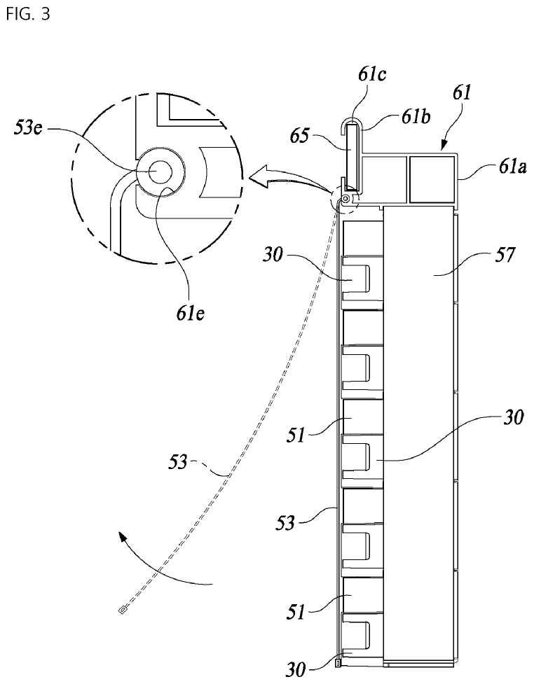

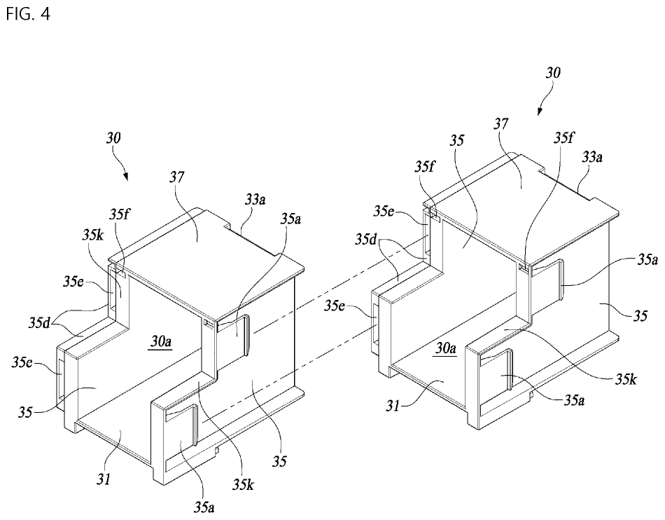

FIG. 1 is a perspective view of a smart medicine box 10 according to an embodiment of the present disclosure, and FIG. 2 is an exploded perspective view of the smart medicine box shown in FIG. 1. Furthermore, FIG. 3 is a side view of the smart medicine box, and FIGS. 4 and 5 are diagrams illustrating a method of assembling unit cases of FIG. 2.

As shown in the drawings, the smart medicine box 10 according to this embodiment includes a case assembly 20, an individual container 51, a support frame 57, a closing-portion supporter 61, a marking portion 65, and a closing portion.

The case assembly 20 is the medicine accommodation portion made by vertically and horizontally connecting a plurality of unit cases 30 to accommodate medicine for each day of the week. The unit cases 30 constituting the case assembly 20 may be composed of seven unit cases in a horizontal direction and five unit cases in a vertical direction. Seven unit cases arranged in the horizontal direction indicate respective days of one week, while five unit cases arranged in the vertical direction indicate five weeks. The case assembly 20 itself expresses a calendar.

The unit cases 30 are manufactured through injection molding using synthetic resin, have the same shape, and may be assembled with and disassembled from each other.

As shown in FIGS. 4 and 5, the unit case 30 includes a bottom portion 31, sidewall portions 35, a rear-wall portion 33, and a ceiling portion 37 to define an accommodation space 30a. The accommodation space 30a is a space that accommodates the individual container 51.

The bottom portion 31 is a horizontal surface that holds the individual container 51, and the sidewall portions 35 are vertical walls that are integrally provided on both ends of the bottom portion in a width direction thereof to correspond to both sides of the individual container. The sidewall portions 35 may be in surface contact with the sides of the individual container 51.

Especially among both sidewall portions, one sidewall portion 35 has on an outer surface thereof two holders 35d, and an opposite sidewall portion 35 has on an outer surface thereof two locking buckles 35a. Furthermore, a fitting hole 35e opened at a front thereof is formed in each holder 35d. In this description, the term “front” refers to a surface facing a user.

The fitting hole 35e is a hole that fixedly accommodates the locking buckle 35a of a unit case 30 that is horizontally adjacent to the unit case. By inserting the locking buckle 35a of one of the two unit cases 30 into the fitting hole 35e of the other unit case, the unit cases are coupled to each other in the horizontal direction.

Furthermore, a receiving hole 35f opened at a front is formed in an upper end of the sidewall portion 35, and a fitting protrusion 31c is provided on an underside of the bottom portion 31. The fitting protrusion 31c is a protrusion that is fitted into the receiving hole 35f of a unit case that is vertically adjacent to the unit case. By inserting the fitting protrusion 31c into the receiving hole 35f, the unit cases are vertically assembled with each other.

In addition, a support groove 33a is provided in an upper end of the rear-wall portion 33, and a catch protrusion 31e is provided on a lower end thereof. The support groove 33a accommodates the catch protrusion 31e, thus preventing the fitting protrusion 31c from being removed from the receiving hole 35f.

Both the sidewall portions 35 are provided with individual-container exposure grooves 35k. Each individual-container exposure groove 35k is a groove made by cutting a part of a rectangular sidewall portion, and exposes a part of each side of the individual container 51, as shown in FIG. 2. The individual-container exposure groove 35k exposes the side of the individual container accommodated in the accommodation space 30a of the unit case, thus allowing a user to hold both sides of the individual container.

The individual-container exposure groove 35k allows the individual container 51 to be more easily taken out, even if the upper end of the individual container 51 is in almost contact with the underside of the bottom portion 31 of the unit case located at an upper position.

The case assembly 20 is a structure by horizontally and vertically connecting and assembling the plurality of unit cases 30 configured as described above. If necessary, an additional unit case 30 may be connected horizontally or vertically. Further, the aspect ratio of the case assembly may be changed, or the case assembly may be composed of six or less unit cases 30 in the horizontal direction and four or less unit cases in the vertical direction.

Furthermore, each unit case 30 may have a different color. For instance, it is possible to change a color for each day of the week, or provide different colors to a row and a column.

The individual container 51 is accommodated in each of the unit cases 30 constituting the case assembly 20. The individual container 51 is a container that accommodates medicine to be taken, and is opened at a top thereof. Particularly, a partition plate 51c is mounted in an internal space 51a of the individual container 51. The partition plate 51c partitions the internal space 51a to accommodate medicine for each time. For example, medicine taken in the morning and medicine in the evening may be separately put into the internal space. Of course, two or more partition plates 51c may be installed to form more spaces.

The support frame 57 has the shape of a rectangular frame, and fixedly accommodates the case assembly 20. The case assembly 20 is fitted into an assembly accommodation space 57a of the support frame 57. The support frame 57 covers the locking buckle 35a or the holder 35d of the unit case 30 located on an outer periphery, thus creating a simpler appearance.

The closing-portion supporter 61 is mounted on the top of the support frame 57 to support a closing cover 53, which will be described later, and accommodate the marking portion 65.

The closing-portion supporter 61 has the sectional shape of a window frame, and extends in a longitudinal direction. The closing-portion supporter 61 has a fixing body 61a and a cross beam 61b.

The fixing body 61a is a portion that is in close contact with and fixed to the upper surface of the support frame 57. The fixing body 61a may be coupled to the support frame 57 through various methods such as an adhesion method, a taping method, or a screw-type fastening method.

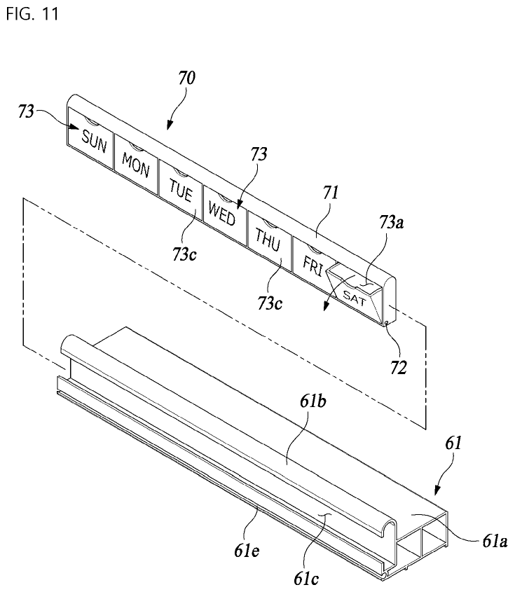

The cross beam 61b is integrated with the fixing body 61a, is a portion protruding forwards from the support frame 57, and is provided with a horizontal receiving portion 61c and a linear groove 61e. The horizontal receiving portion 61c is a space that is open at a front thereof while having a predetermined width, and receives the marking portion 65 or a portable medicine box 70 (see FIG. 11). As shown in FIG. 3, the linear groove 61e catches the upper end of the closing cover 53.

The marking portion 65 is a strip-shaped plate in which days of the week are marked on a front thereof. Through the marking portion 65, it is possible to easily check with the naked eye what day of the week corresponds to a vertical column in the case assembly 20.

Meanwhile, the closing portion is the closing cover 53 that covers the front of the case assembly 20 to protect the individual container 51 and to prevent the individual container 51 from spilling forwards, and has an area that may cover the front of the case assembly 20.

The closing cover 53 is formed of a flexible sheet, and has on an upper end thereof a catch wire 53e. The catch wire 53e is fixedly inserted into the linear groove 61e while being coupled to the upper end of the closing cover 53. The closing cover 53 is closed by the action of gravity while being supported by the closing-portion supporter 61. The closing cover 53 may be made of silicon fabric.

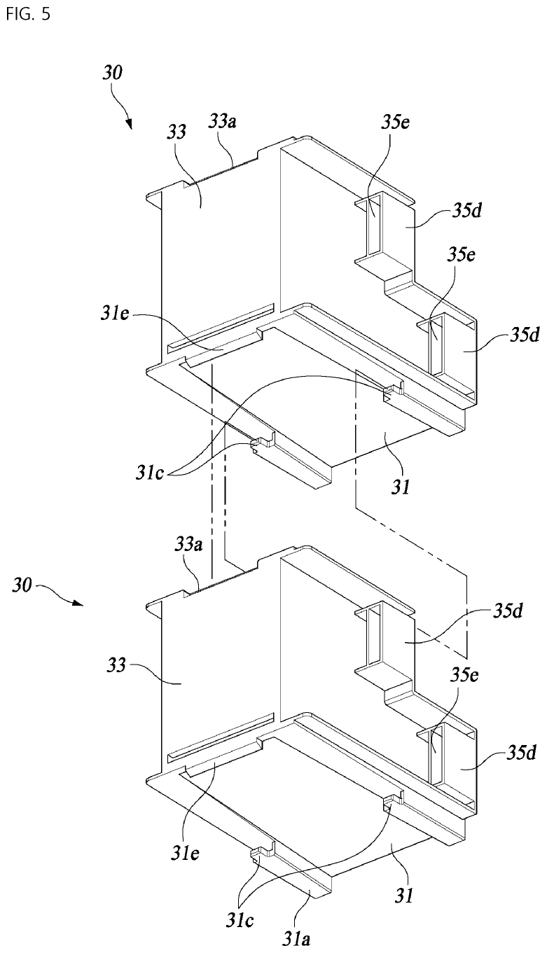

In addition, cover-sensor portions 53c are installed on both sides of the closing cover 53. The cover-sensor portion 53c is a sensing portion for detecting that a user lifts the closing cover 53. The contents detected by the cover-sensor portion 53c are transmitted to a terminal 81 (see FIG. 6) of a user or a manager. The sensing method or the installing position of the cover-sensor portion 53c having the above-described function may be changed as desired.

FIG. 6 is a block diagram illustrating a method of using the smart medicine box shown in FIG. 1.

If a user lifts the closing cover 53 to take medicine, the cover-sensor portion 53c detects the user's action and sends the detected contents to the terminal 81. The terminal 81 may be a smart phone of a medicine taker, a caregiver, or a manager.

The terminal 81 automatically sends administration information, informing that a user has taken medicine, to an external manager (AI) 83. The external manager (AI) 83 identifies that a medicine taker takes medicine through the administration information, and sends management information to the terminal. The management information may include precautions after a user taking medicine, a next administration time, etc. The manager 83 is a doctor or a nurse of a hospital or a public health center or an AI.

As such, the sensor portion is installed at the closing cover to detect a user's action and the AI is utilized, so that it is possible to analyze a life pattern and to determine that the user takes medicine at a specified time. Moreover, in case the user only lifts the closing cover 53 and does not actually take medicine, IOT technology is applied to analyze the operating time of objects (refrigerator, gas stove, etc.), thus allowing a medicine taking state to be precisely identified.

Further, the terminal 81 may provide administration instruction to a user. For example, when no signal is generated from the cover-sensor portion 53c even after administration time has elapsed, the administration instruction is transmitted to the user by text or sound.

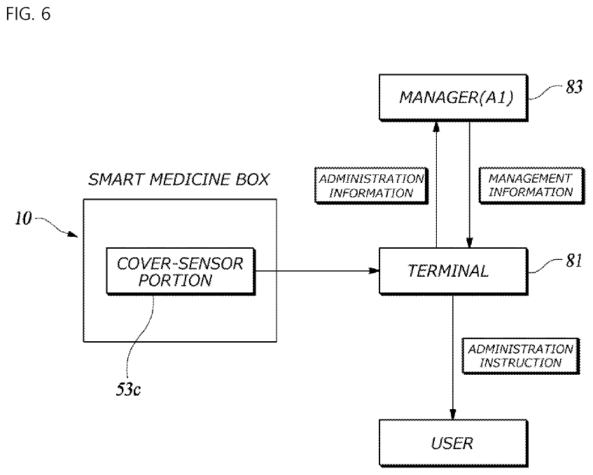

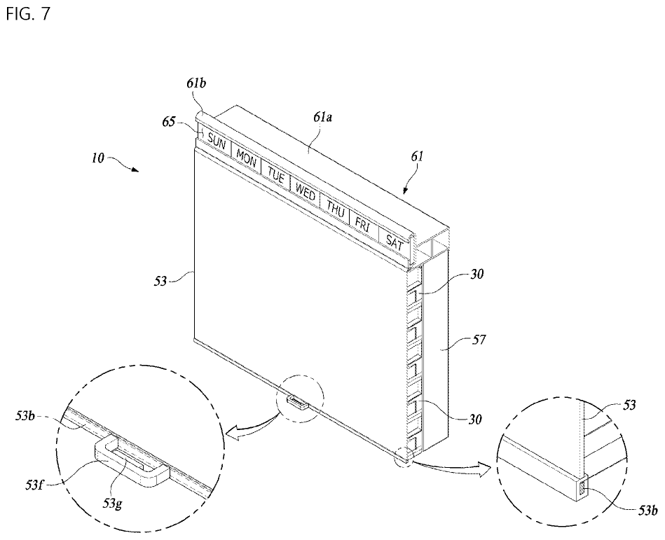

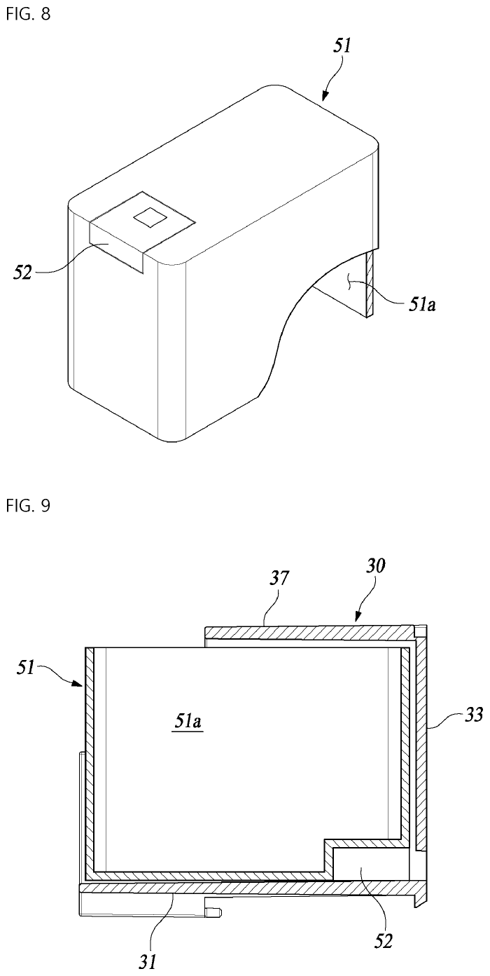

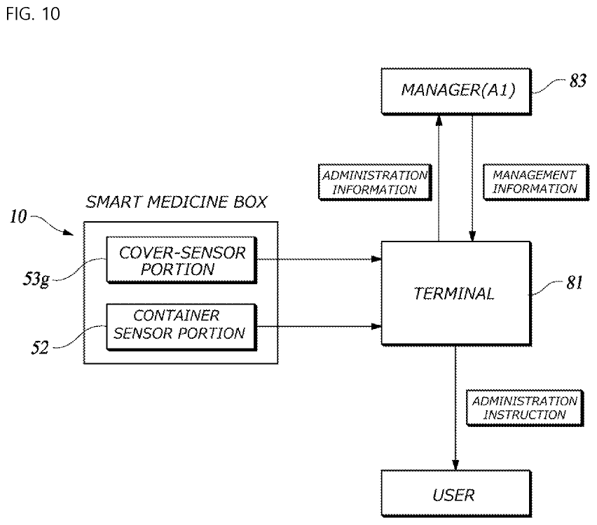

FIG. 7 is a diagram showing a smart medicine box 10 according to a modification of the present disclosure, and FIG. 8 is a cutaway perspective view of an individual container that may be applied to the smart medicine box of FIG. 7. Further, FIG. 9 is a sectional view showing the individual container accommodated in a unit case of FIG. 7. FIG. 10 is a block diagram illustrating a method of using the smart medicine box of the modification shown in FIG. 7.

Hereinafter, the same reference numerals as the above-described reference numerals denote the same members having the same function.

Referring to the drawings, it can be seen that a weight strip 53b is provided on the lower end of the closing cover 53. The weight strip 53b is a rod-shaped member that extends horizontally while having a predetermined thickness and width, and downwardly pulls the closing cover 53 taut by gravity. The weight strip 53b prevents the closing cover 53 from being lifted, even if a fan blows, for example.

Furthermore, a handle 53f is provided on an outer surface of a lower end of the closing cover 53. The handle 53f is a portion held by a user's hand so as to open the closing cover 53, and has a cover-sensor portion 53g. The function of the cover-sensor portion 53g is the same as that of the above-described cover-sensor portion 53c (see FIG. 1).

Meanwhile, a container-sensor portion 52 is mounted on an underside of the individual container 51. The container-sensor portion 52 is a sensor that generates a signal when the individual container 51 moves on the bottom portion 31. The signal generated by the container-sensor portion 52 is transmitted to the terminal 81, as shown in FIG. 10.

The smart medicine box 10 of a type shown in FIG. 7 uses two sensor portions, i.e., the cover-sensor portion 53g and the container-sensor portion 52. The cover-sensor portion 53g and the container-sensor portion 52 are detecting portions that are independently driven, and transmit the detected contents to the terminal 81.

The detected signal is input twice into the terminal 81. In other words, the detected signal is received once when a user holds the handle 53f and opens the closing cover 53, and the detected signal is received once when the individual container 51 is taken out. The information received in the terminal 81 is immediately transmitted to the manager (AI) 83.

The manager 83 determines that a user has correctly taken medicine, when the signal of the cover-sensor portion 53g and the signal of the container-sensor portion 52 are sequentially input at predetermined time intervals. When only the signal of the cover-sensor portion 53g is input and the signal of the container-sensor portion 52 is not input, it is determined that normal administration is not performed, so that the terminal 81 instructs a user to take medicine.

FIG. 11 is a diagram showing a portable medicine box 70 that may be applied to the smart medicine box according to an embodiment of the present disclosure.

As shown in the drawing, the portable medicine box 70 may be mounted on the horizontal receiving portion 61c of the closing-portion supporter 61. The portable medicine box 70 includes individual cases 73 that are separated by the days of the week.

The individual case 73 defines a receiving space 73a receiving medicine that is to be taken, and is rotatable forwards and backwards while being supported by the support shaft 72. When the individual case rotates forwards, the individual case is opened. On the other hand, when the individual case rotates backwards, it is received in the medicine-box body 71.

In addition, a mark-surface portion 73c is provided on the front of the individual case 73. The mark-surface portion 73c is a portion on which the day of the week is marked, and serves as the above-described marking portion 65.

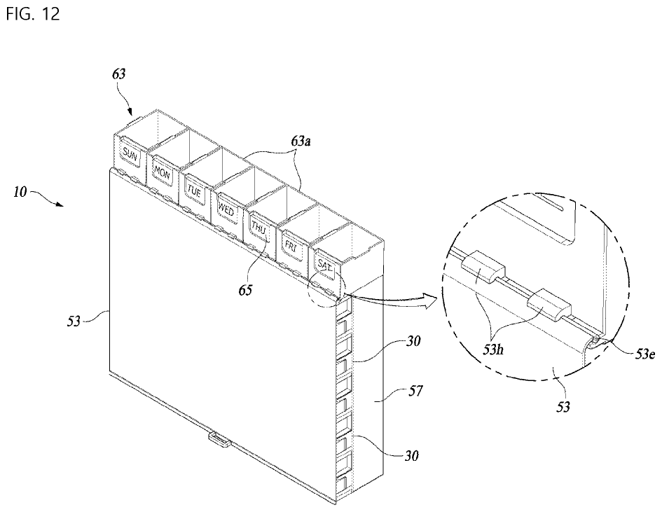

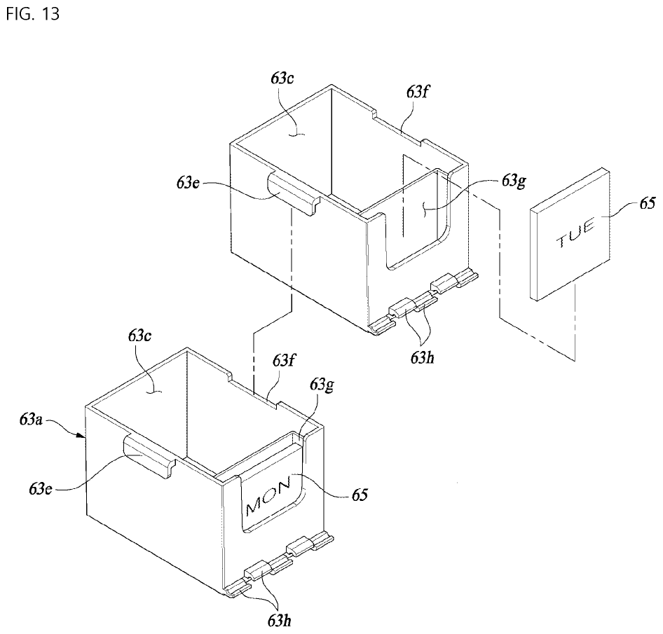

FIG. 12 is a perspective view showing a smart medicine box 10 of this embodiment to which another type of closing-portion supporter 63 is applied, and FIG. 13 is a diagram showing the structure of an upper case forming the closing-portion supporter of FIG. 12.

Referring to the drawings, it can be seen that another type of closing-portion supporter 63 is installed on the top of the case assembly 20. The basic function of the closing-portion supporter 63 is the same as that of the closing-portion supporter 61 shown in FIG. 2.

The closing-portion supporter 63 of FIG. 12 is configured by laterally connecting seven upper cases 63a to each other. Each upper case 63a has the same shape.

The upper case 63 defines an article accommodation space 63c that is opened at a top thereof. The article accommodation space 63c may accommodate various articles therein. For example, band-aids, ointments, liquid painkillers, nail clippers, scissors, smart phones, or the like may be put into the article accommodation space. In addition, a front pocket 63g is provided on the front of the article accommodation space 63c. The front pocket 63g is a space into which the above-described marking portion 65 is accommodated.

Furthermore, a coupling hook 63e is formed on one sidewall of the upper case 63a, and a hook coupling groove 63f is formed on an opposite sidewall thereof. The hook coupling groove 63f accommodates the coupling hook 63e. The coupling hook 63e of one upper case 63a among two upper cases 63a that are adjacent to each other in a lateral direction is fitted into the hook coupling groove 63f of a neighboring upper case 63a, so that the coupling of the upper cases 63a is maintained.

Furthermore, an elastic finger 63h is provided on the lower end of the front of each upper case 63a. The elastic finger 63h accommodates and fixes the upper end of the closing cover 53, and has the function of the linear groove 61e shown in FIG. 3. In other words, the closing cover 53 accommodates and fixes the catch wire 53e provided on the upper end. The shape of the elastic finger that may perform such a function may be changed in various ways.

While the present disclosure has been described with reference to preferred embodiments, it is apparent to those skilled in the art that these embodiments have been described for illustrative purposes, and various changes and modifications may be made without departing from the spirit and scope of the present disclosure as defined by the appended claims.

1. A smart medicine box, comprising:
a medicine accommodation portion having a plurality of accommodation spaces that are opened at a front thereof and accommodate medicine that is to be taken; and
a closing portion that covers a front of the medicine accommodation portion to protect the medicine and is opened to take the medicine out from the box.

2. The smart medicine box of claim 1, wherein the closing portion comprises a sensor portion configured to detect opening of the closing portion.

3. The smart medicine box of claim 1, wherein the medicine accommodation portion is a case assembly made by assembling a plurality of unit cases that may be assembled with and disassembled from each other while each having an accommodation space that is opened at a front thereof.

4. The smart medicine box of claim 3, wherein an individual container configured to contain medicine that is to be taken is accommodated in the accommodation space of the unit case.

5. The smart medicine box of claim 4, wherein the unit case comprises a bottom portion configured to hold the individual container, and sidewall portions integrally provided on both ends of the bottom portion in a width direction thereof to correspond to both sides of the individual container,
one sidewall portion among both the sidewall portions comprises a holder having a fitting hole, and an opposite sidewall portion comprises a locking buckle coupled to the fitting hole of an adjacent unit case in a lateral direction,
a receiving hole opened at a front is formed in an upper end of each of the sidewall portions, and
a fitting protrusion is located on an underside of the bottom portion to be fitted into the receiving hole of a unit case that is vertically adjacent to the unit case.

6. The smart medicine box of claim 5, wherein the sidewall portion comprises an individual-container exposure groove configured to expose a side of the individual container accommodated in the accommodation space of the unit case, thus allowing a user to hold both sides of the individual container in the unit case.

7. The smart medicine box of claim 3, further comprising:
a support frame having a shape of a rectangular frame to accommodate and support the case assembly.

8. The smart medicine box of claim 4, wherein a closing-portion supporter is further installed on a top of the case assembly to support an upper end of the closing portion.

9. The smart medicine box of claim 8, wherein the closing portion is a closing cover that is formed of a flexible sheet having an area that may cover a front of the case assembly, and is closed by the action of gravity while being supported at an upper end thereof by the closing-portion supporter.

10. The smart medicine box of claim 9, wherein the closing cover further comprises a cover-sensor portion configured to detect that a user lifts the closing cover, and to transmit detected contents to the outside.

11. The smart medicine box of claim 8, wherein the closing-portion supporter comprises a horizontal receiving portion that has a predetermined width and is opened at a front thereof, and
the horizontal receiving portion is equipped with a marking portion on which the days of week are marked.

12. The smart medicine box of claim 8, wherein the closing-portion supporter comprises a horizontal receiving portion that has a predetermined width and is opened at a front thereof, and
the horizontal receiving portion is equipped with a portable medicine box that separately contains medicine for each day of the week.

13. The smart medicine box of claim 8, wherein the closing-portion supporter comprises a plurality of upper cases that provide article accommodation spaces and are coupled to each other while being adjacent to each other in a lateral direction.

14. The smart medicine box of claim 13, wherein each of the upper cases further comprises a front pocket that is separated from the article accommodation space and accommodates a marking portion on which the day of the week is marked.

15. The smart medicine box of claim 10, wherein the individual container is a receiving case configured to receive medicine for each day of the week, and comprises therein a partition wall configured to partition a space of the individual container.

16. The smart medicine box of claim 15, wherein the individual container further comprises a container-sensor portion configured to generate a motion signal of the individual container and transmit the motion signal to the outside, when the individual container is moved in a state where a user lifts the closing cover.
